(19) United States
(12) Patent Application Publication
(10) Pub. No.: US 2011/0254544 A1
(43) Pub. Date: Oct. 20, 2011

(54) METHOD AND DEVICE FOR MEASURING THE LAYER THICKNESS OF PARTIALLY SOLIDIFIED MELTS

(75) Inventors: Norbert Vogl, Ratingen (DE); Jörg Bausch, Dusseldorf (DE)

(73) Assignee: SMS SIEMAG AKTIENGESELLSCHAFT, Dusseldorf (DE)

(21) Appl. No.: 13/140,897

(22) PCT Filed: Dec. 18, 2009
(86) PCT No.: PCT/EP09/09140

§ 371 Date: Jun. 20, 2011

(30) Foreign Application Priority Data
Dec. 20, 2008 (DE) 10 2008 064 304.1

(51) Int. Cl. G01B 7/06

(52) U.S. Cl. 324/229

(57) ABSTRACT

The present invention relates to a method and a device for measuring the layer thickness of partially solidified melts, particularly on a conveyor belt, during continuous casting. In order to determine the layer thickness, magnetic fields are used, which are created by means of electromagnetic stirring coils that are present on one side of the layer. The reduced magnetic field is then detected on the other side of the layer and is used for calculating the layer thickness.

### FIELD OF THE INVENTION

The invention concerns a method and a device for measuring the layer thickness of partially solidified melts, especially on a conveyor belt, as part of a strip casting process.

### PRIOR ART

Prior-art methods are known which are capable of determining the layer thickness of completely solidified melts on a conveyor belt by means of ultrasound, x-rays, or lasers. However, these methods are not suitable for determining the layer thickness of partially solidified melts, whose surface temperatures can be, for example, up to 1500° C.

In addition, DE 34 23 977 discloses a method for determining the thickness of a solidified skin of a melt, in which the application of a magnetic alternating field generates eddy currents in the melt, which are detected by electromagnetic induction, from which the thickness of the skin can be deduced. The thickness of a skin is determined from the strength of the eddy currents according to the difference of the resistivity between an unsolidified part and solidified part Therefore, the eddy currents are measured on the same surface of the melt to which the magnetic field is applied. However, this requires additional coil systems suitable for this purpose.

EP 1 900 454 describes a method for the continuous casting of steel, in which pulsed electromagnetic ultrasonic waves are generated, which are partly modulated and passed through the strand. The magnetic permeability in the strand is changed by these ultrasonic waves due to the magnetostriction that occurs. The transmitted magnetic ultrasonic waves are measured by electromagnetic induction and used to determined the progress of the solidification of the melt by correlation. This method requires expensive and complicated measuring apparatus that is capable of generating pulsed modulated fields and then detecting and correlating them.

DE 3110900 describes a method for measuring the shell thickness of solidifying metals, in which a transmitter coil and a receiver coil are used. Depending on the conductivity distribution, the electromagnetic fields penetrate the test material more or less deeply. The resulting total field induces in the receiver coil a current that is shifted in its phase and amplitude relative to the original field.

These methods and devices for characterizing shell or layer thicknesses are relatively complicated and expensive.

The objective of the invention is thus to provide a simpler and less expensive system that makes it possible to determine the layer thickness of a partially solidified melt. In addition, this system should take up less space than is the case in the cited documents.

The objective described above or, optionally, parts thereof are achieved by the present invention, especially by the following features.

The invention concerns, first of all, a method for measuring the layer thickness of partially solidified melts on a conveyor belt by means of magnetic fields as part of a strip casting process, wherein a magnetic field is generated on one side of the partially solidified melt, penetrates the partially solidified melt, and is measured on the other side of the partially solidified melt, wherein the attenuation of the magnetic field on the other side of the partially solidified melt is used to compute the layer thickness of the partially solidified melt, and wherein electromagnetic stirring coils are used to generate the magnetic field.

Stirring coils of this type are usually already present in a strip casting system. Therefore, no additional coils that take up extra space or produce added costs have to be installed to generate suitable magnetic fields.

The term “attenuation of the electronic field” means the remaining residual field strength or the difference between the transmitted power and the received power of the electric field.

In a preferred form of the method, the generated magnetic fields have frequencies of 500 Hz to 10,000 Hz.

In another preferred form, the electromagnetic stirring coils are operated with frequencies of less than 20 Hz, and during the operation of the stirring coils, harmonic waves arise that have frequencies of 500 Hz to 10,000 Hz.

Such frequencies can then be used directly for determining the layer thickness, so that no additional devices are needed to generate the frequencies.

Another preferred embodiment of the method has the feature that frequencies of 500 Hz to 10,000 Hz are fed directly into the coils of the stirrers.

Another preferred embodiment of the method has the feature that several frequencies between 500 Hz and 10,000 Hz are used to measure the layer thickness.

The use of several frequencies allows even more accurate characterization of the layer thickness.

Another preferred embodiment of the method has the feature that several sensors are arranged over the width of the conveyor belt to obtain several measuring points.

This feature makes it possible to obtain a more accurate resolution of the layer thickness of the melt with respect to the width of the conveyor belt.

In another preferred embodiment, the method is used in a thin strip casting process, in which the layer thickness of the partially solidified melt is 10-30 mm.

Another preferred embodiment of the method has the feature that the fields are generated above or, optionally, below the partially solidified melt and are measured below or, optionally, above the partially solidified melt.

Another preferred embodiment of the method has the feature that the magnetic field is homogeneously generated over the width of the conveyor belt.

In addition, the invention also includes a device corresponding to the method of the invention. This device offers essentially the same advantages as the method of the invention described above. Accordingly, the invention concerns a device for measuring the layer thickness of partially solidified melts on a conveyor belt. This device comprises the following: a unit for generating a magnetic field on one side of the partially solidified melt and at least one sensor for measuring the magnetic field on the other side of the partially solidified melt after the magnetic field has penetrated the partially solidified melt, such that the unit for generating the magnetic field consists of electromagnetic stirring coils and such that the device is designed in such a way that the attenuation of the magnetic field measured by the sensors on the other side of the partially solidified melt is used to compute the layer thickness of the partially solidified melt.

In a preferred embodiment of the device, the stirring coils generate magnetic fields with frequencies of 500 Hz to 10,000 Hz.

In another preferred embodiment of the device, the electromagnetic stirring coils are operated with frequencies of less than 20 Hz, and during the operation of the stirring coils, harmonic waves arise that have frequencies of 500 Hz to 10,000 Hz.

In another preferred embodiment of the device, frequencies of 500 Hz to 10,000 Hz are fed directly into the coils of the stirrers.

In another preferred embodiment of the device, the stirring coils generate several frequencies between 500 Hz and 10,000 Hz.

In another preferred embodiment of the device, the distance between the electromagnetic stirring coils and the sensors is 50-150 mm.

Finally, the invention also comprises an installation, which includes a conveyor belt of a strip casting installation for conveying a partially solidified melt as well as a device for determining the layer thickness of the partially solidified melt, in accordance with one of the aforementioned embodiments of the device of the invention.

In another preferred embodiment of the installation, the device for determining the layer thickness of the partially solidified melt comprises several sensors, which are arranged over the width of the conveyor belt, so that there are several measuring points in the direction of the width.

In another preferred embodiment of the installation, the electromagnetic stirring coils are arranged at a distance of less than 150 mm above and/or below the partially solidified melt.

### BRIEF DESCRIPTION OF THE FIGURES

The figures, which show some embodiments of the invention, are briefly described below. However, the invention is not limited to these embodiments. Further details and possible embodiments are given in the detailed description of the embodiments.

FIG. 1 is a perspective view of a simplified example of a system of stirring coils arranged above the melt.

FIG. 2 is a perspective view of a simplified example of the same system of stirring coils arranged above the melt that is shown in FIG. 1 but as seen from the underside of the melt.

FIG. 3 is a graph that illustrates examples of the dependence of the detected magnetic field on different generated magnetic field frequencies and on the layer thickness.

### DETAILED DESCRIPTION OF THE EMBODIMENTS

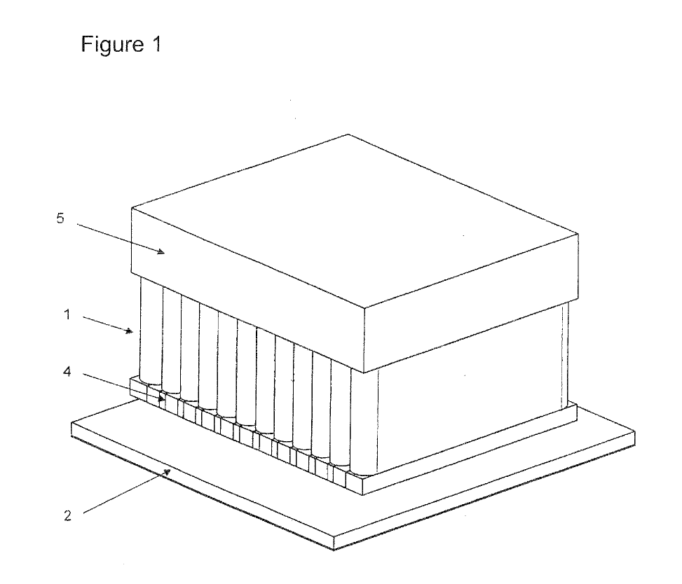

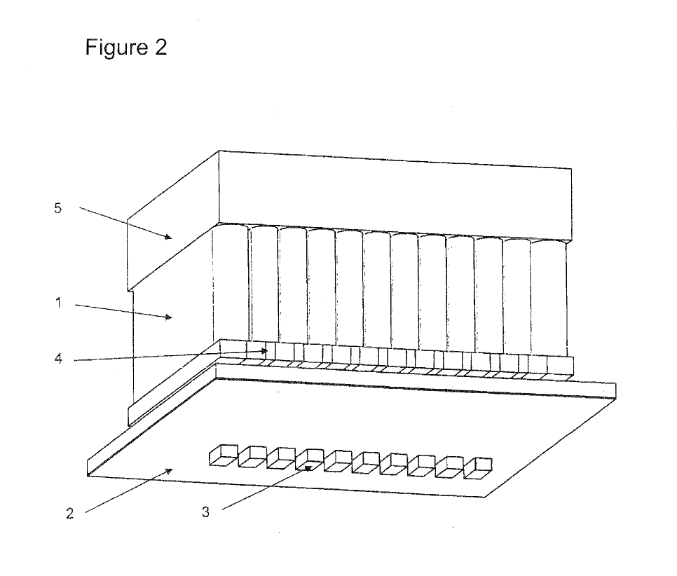

FIG. 1 shows an example of an embodiment of the invention. Magnetic stirring coils 1 generate a magnetic field above the melt 2. The measurement involves the generation of a magnetic field, which penetrates the melt 2 and is detected by sensors 3 (see FIG. 2) located on the underside of the melt 2. In particular, in the embodiment of FIG. 1, iron cores 4 and a corresponding yoke 5 are used to increase the efficiency of the stirring coils. Below the stirring coils 1, the iron cores 4 are separated by regions that act as insulation to the magnetic flux. These regions consist of a material that is suitable for this purpose, e.g., copper. On the upper side of the coils, the yoke 5 joins all of the iron cores 4. The use of the iron cores 4 and the yoke 5 is not necessary but rather constitutes only one embodiment of stirring coils for generating magnetic fields.

In addition, during the measurement, the partially solidified melt 2 is preferably positioned on a conveyor belt (not shown in the drawing) in the vicinity of the stirring coils 1. The conveyor belt is preferably moving during the measurement but it can also be stopped. The measurement can also be made in the area of the agitated molds.

Partly solidified means that the melt 2 is partly liquid and partly solid. However, it is also possible to make the measurement with the melt 2 in a completely liquid form or in a completely solidified form. It is thus possible to make a quantitative determination of the liquid, partially solidified, or solidified melt 2. If necessary, it is also possible to determine only the layer thickness of a solidified skin of the melt. The surface of the melt 2 can have a temperature of up to 1500° C. during the measurement. These temperatures can also be higher for certain materials, but this does riot adversely affect the measurement in accordance with the present invention.

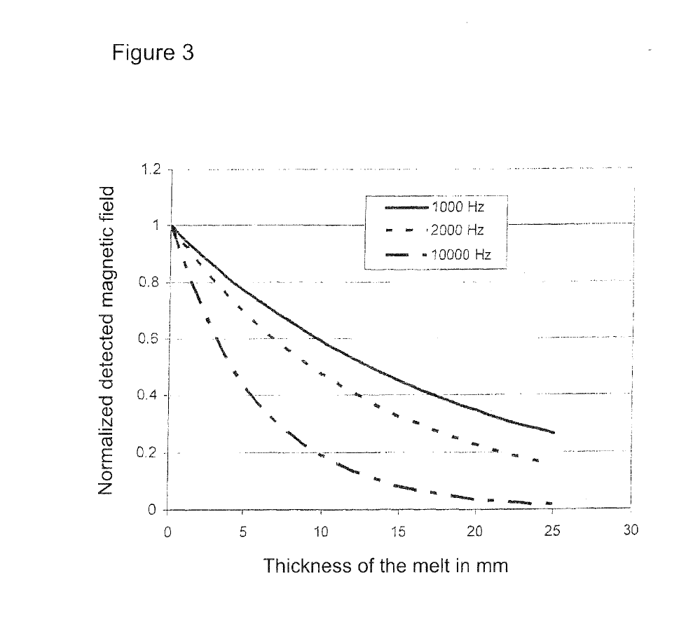

In FIG. 1, the magnetic field is generated on the upper side of the melt 2 with a stirring coil 1. However, the stirring coils 1 can also be placed below the melt 2. On the other side of the layer, a suitable sensor 3 can measure the attenuation of the magnetic field (see FIG. 3). In this regard, the distance between the stirring coils and the sensor 3 is preferably 50-150 mm. The thickness of the measured melt 2 is between these values and preferably can be 10-30 mm. In this specific case, a thin strip casting process is involved. However, it is also possible to have other arrangements, in which the distance between the stirring coil 1 and the sensor 3 is greater, e.g., up to 400 mm, and the thickness of the melt is up to 350 mm.

The stirring coils 1 that are used are preferably operated at frequencies of less than 20 Hz. However, depending on the specific application, frequencies of up to 100 Hz are also possible. The transformation of the mains current to the operating current of the stirring coils 1 gives rise to harmonic waves in the range provided for the measurement of the layer thickness, i.e., the range of 500 Hz to 10,000 Hz. These oscillations or frequencies can be used for the measurement of the layer thickness. However, depending on the application, it is also possible to feed the necessary frequencies or currents with these frequencies into the stirring coils 1 to achieve higher field intensities.

In addition, before the start of the measurement, a zero point of the measurement can be determined, i.e., a measurement can be performed without a melt 2 in order to make it possible, for example, to eliminate from the measurement the effect of a conveyor belt or other factors.

The measurement can be still further improved if the magnetic field is measured on both sides of the melt 2. For this purpose, sensors 3 can be arranged on both sides of the melt 2. In addition, it is possible to use several measuring frequencies to improve the measurement accuracy and to compensate for any disturbances.

A homogeneous electromagnetic field can be generated, especially over the width of the system, by the available stirring coils 1. In this regard, the width is understood to be perpendicular to the casting direction.

FIG. 2 shows the same system as FIG. 1 but as seen from the underside of the melt. This view reveals the sensors 3, which are installed below the melt 2. In this case, the sensors 3 are arranged perpendicularly to the conveyor belt, i.e., in the direction of the width. Alternatively, however, it is possible to provide only one sensor 3. Furthermore, the number of sensors 3 is limited only by the structural conditions of the casting installation, so that it is even possible to provide more sensors than are shown in FIG. 2. When several sensors 3 are used, several measuring points are obtained. Thus, several sensors 3, for example, 2-20 sensors, can be arranged along the width of the melt 2 to obtain information about the variation of the layer thickness of the melt 2 in the direction of the width.

FIG. 3 shows an example of the detected magnetic field, normalized to one, as a function of the layer thickness of the melt. In this example, the effect of the presence of a conveyor belt on the detected signal has already been eliminated during the calibration process. The example illustrated in FIG. 3 shows layer thicknesses of the melt between 0 mm, i.e., no melt introduced, and 25 mm. It is clearly apparent that the normalized detected field decreases with increasing layer thickness. Furthermore, it is apparent that a frequency of 10,000 Hz leads to more rapid attenuation of the detected field with increasing thickness of the melt than lower frequencies. Thus, the detected magnetic field becomes attenuated less strongly with increasing thickness of the melt for fields with a frequency of 2000 Hz, and the detected magnetic field becomes attenuated less strongly still for fields with a frequency of 1000 Hz. In general, it can be stated that electrically conductive materials, magnetic alternating fields produce eddy currents, which in turn generate a magnetic field that is directed opposite the original field, so that the resulting detected field is weaker than the generated field. The extent to which eddy currents can form in the melt depends, among other factors, on the electrical conductivity and the permeability of the specific melt and on the frequency of the generated, applied magnetic fields. If the material is ferromagnetic, then, in addition, magnetic field energy is converted to heat by magnetic reversals of the magnetic moments within the melt, which likewise causes attenuation of the generated field. In addition, the effect of magnetostriction can occur, by which magnetic field energy is also lost. Above the Curie temperature, above which a material of this type is paramagnetic, the latter effects do not occur, so that in this case, magnetic field energy is only dissipated mainly due to the formation of eddy currents. The depth of penetration of eddy currents and thus the depth of penetration of the magnetic field is approximately inversely proportional to the square root of the frequency of the applied fields, the conductivity of the material, and its relative permeability. This means that in the case of a very high conductivity or a very large relative permeability, eddy currents form only in regions close to the surface of the melt and not farther inside the melt, because the magnetic field energy is already almost completely lost at the surface by the formation of eddy currents. In general, it is clear that at a fixed magnetic field frequency, the normalized detected magnetic field decreases with increasing thickness of the melt, since more material, in which, for example, eddy currents form, is in the path of the field. As a result, more energy is dissipated with increasing thickness of the melt. Thus, at a frequency of 10,000 Hz and a layer thickness of 25 mm, the melt is so thick that almost the entire field energy is absorbed by the melt. At the same frequency and even greater layer thickness, the depth of penetration of the magnetic field is then even less than the layer thickness of the melt. As FIG. 3 shows, however, the fields with frequencies of 1000 Hz and 2000 Hz are still able to penetrate the melt even at a thickness of 25 mm.

### LIST OF REFERENCE NUMBERS

1 stirring coils

2 melt

3 sensors

4 iron cores

5 yoke

1-18. (canceled)

19. A method for measuring layer thickness of partially solidified melts on a conveyor belt using magnetic fields as part of a strip casting process, the method comprising the steps of: generating a magnetic field on one side of the partially solidified melt using electromagnetic stirring coils so that the magnetic field penetrates the partially solidified melt; measuring, on the other side of the partially solidified melt, a remaining residual field strength of the magnetic field, which is attenuated during penetration of the melt; and, using the measured residual field strength to compute the layer thickness of the partially solidified melt.

20. The method in accordance with claim 19, wherein the generated magnetic fields have frequencies of 500 Hz to 10,000 Hz.

21. The method in accordance with claim 19, wherein the electromagnetic stirring coils are operated with frequencies of less than 20 Hz, and during operation of the stirring coils, harmonic waves arise that have frequencies of 500 Hz to 10,000 Hz.

22. The method in accordance with claim 19, including feeding frequencies of 500 Hz to 10,000 Hz are directly into the stirring coils.

23. The method in accordance with claim 19, including using several frequencies between 500 Hz and 10,000 Hz to measure the layer thickness.

24. The method in accordance with claim 19, including arranging several sensors over a width of the conveyor belt to obtain several measuring points.

25. The method in accordance with claim 19, including measuring the layer thickness in a thin strip casting process, wherein the layer thickness of the partially solidified melt is 10-30 mm.

26. The method in accordance with claim 19, including generating the fields above or below the partially solidified melt and measuring the fields below or above the partially solidified melt.

27. The method in accordance with claim 19, including homogeneously generating the magnetic field over a width of the conveyor belt.

28. A device for measuring layer thickness of partially solidified melts on a conveyor belt, comprising: a unit for generating a magnetic field on one side of the partially solidified melt; and at least one sensor for measuring the magnetic field on the other side of the partially solidified melt after the magnetic field has penetrated the partially solidified melt, wherein the unit for generating the magnetic field includes electromagnetic stirring coils, the device being operative to use attenuation of the magnetic field measured by the sensor on the other side of the partially solidified melt to compute the layer thickness of the partially solidified melt.

29. The device in accordance with claim 28, wherein the stirring coils generate magnetic fields with frequencies of 500 Hz to 10,000 Hz.

30. The device in accordance with claim 28, wherein the electromagnetic stirring coils are operated with frequencies of less than 20 Hz so that during operation of the stirring coils harmonic waves arise that have frequencies of 500 Hz to 10,000 Hz.

31. The device in accordance with claim 28, wherein frequencies of 500 Hz to 10,000 Hz are fed directly into the stirring coils.

32. The device in accordance with claim 28, wherein the stirring coils are operative generate several frequencies between 500 Hz and 10,000 Hz.

33. The device in accordance with claim 28, wherein a distance between the electromagnetic stirring coils and the sensors is 50-150 mm.

34. An installation, comprising: a conveyor belt of a strip casting installation for conveying a partially solidified melt; and a device for determining layer thickness of the partially solidified melt, the device for determining layer thickness including a unit for generating a magnetic field on one side of the partially solidified melt, and at least one sensor for measuring the magnetic field on the other side of the partially solidified melt after the magnetic field has penetrated the partially solidified melt, wherein the unit for generating the magnetic field includes electromagnetic stirring coils, the device being operative to use attenuation of the magnetic field measured by the sensor on the other side of the partially solidified melt to compute the layer thickness of the partially solidified melt.

35. The installation in accordance with claim 34, wherein the device for determining the layer thickness of the partially solidified melt comprises several sensors arranged over the width of the conveyor belt so that there are several measuring points in a direction of the width.

36. The installation in accordance with claim 34, wherein the electromagnetic stirring coils are arranged at a distance of less than 150 mm above and/or below the partially solidified melt.
